(19) United States
(12) Patent Application Publication
(10) Pub. No.: US 2025/0314329 A1
(43) Pub. Date: Oct. 9, 2025

(54) INTEGRATED STAINLESS STEEL BUSHING FOR EGR VALVE

(71) Applicant: BorgWarner Inc., Auburn Hills, MI (US)

(72) Inventors: Tony Zhang, Ningbo (CN); Roger Li, Ningbo (CN); Timbo Tian, Ningbo (CN); Alexis Liu, Ningbo (CN)

(21) Appl. No.: 19/171,836

(22) Filed: Apr. 7, 2025

(30) Foreign Application Priority Data
Apr. 7, 2024 (CN) 202420698621.0

(51) Int. Cl. F16K 41/02; F16C 33/06

(52) U.S. Cl. CPC F16K 41/02; F16C 33/06; F16C 2361/91

(57) ABSTRACT

An integrated bushing (30), which is used for an exhaust gas recirculation valve (1), includes: a retaining portion (32) which is formed with a through hole (322) and is configured for mounting and fixing of the integrated bushing (30); and an insulating portion (34) which is formed with a through hole (342) and extends from the retaining portion (32). The retaining portion (32) and the insulating portion (34) are integrally formed as an integral structure. A valve stem sealing apparatus (20) includes the integrated bushing (30) and a sealing assembly (50), and the exhaust gas recirculation valve (1) includes the valve stem sealing apparatus (20).

### CROSS-REFERENCE TO RELATED APPLICATIONS

This application claims priority pursuant to 35 U.S.C. 119 (a) to Chinese Patent Application No. 202420698621.0, filed Apr. 7, 2024, which application is incorporated herein by reference in its entirety.

### TECHNICAL FIELD

The present application relates generally to the field of engines, and, in particular, to an integrated bushing for an exhaust gas recirculation valve. The present application further relates to a valve stem sealing apparatus comprising the above-mentioned integrated bushing. In addition, the present application also relates to an exhaust gas recirculation valve comprising the above-mentioned valve stem sealing apparatus.

### BACKGROUND

An exhaust gas recirculation (EGR) valve controls exhaust gas flow by means of a valve stem moving vertically. Existing valve stem guide sealing structures comprise, from top to bottom, a sealing ring, a retaining frame, a sealing ring, a sleeve, a wiper, a heat shield and a retaining washer; the structure has the following disadvantages: 1. when a valve housing is corroded by an exhaust gas environment to produce a powder, the structure cannot prevent dust from entering a gap between the sleeve and the valve stem, and, after long-term operation of the valve, the accumulation of dust causes an increase in valve stem movement resistance, with serious consequences such as causing a valve response delay and even causing the valve to jam; 2. the entry of corrosive contaminants may subsequently cause the valve stem to stick to the wiper or the sleeve, resulting in valve failure; and 3. when the valve housing is corroded by an exhaust gas environment, a rivet point of the retaining washer that is fixed on the valve housing will come off, losing a fixing effect on the retaining washer, and thus the retaining washer, the heat shield and the wiper fall off in succession.

### SUMMARY

One of the objects of the present application is to provide an integrated bushing, valve stem sealing apparatus and exhaust gas recirculation valve capable of overcoming at least one defect in the prior art.

An object of the present application is to provide a new type of sealing structure for an exhaust gas recirculation valve, which can overcome the drawbacks of conventional sealing structures, improving the sealing performance and ensuring stable operation of an exhaust gas recirculation system.

According to a first aspect of the present application, an integrated bushing is provided, which is used for an exhaust gas recirculation valve, characterized in that the integrated bushing comprises:
a retaining portion, the retaining portion being formed with a through hole and being configured for mounting and fixing of the integrated bushing; and
an insulating portion, the insulating portion being formed with a through hole and extending from the retaining portion,
wherein the retaining portion and the insulating portion are integrally formed as an integral structure.

The integrated bushing is formed as a single component, which can simplify the structure of the bushing, and provides a better sealing effect, preventing dust, debris and contaminants from entering a gap between the sleeve and the valve stem which causes the valve stem to stick to relevant components, and the integrated bushing can be more securely mounted to a valve housing of the exhaust gas recirculation valve 1.

According to some embodiments of the present application, the retaining portion may comprise a flange, the flange being arranged around a through hole of the retaining portion.

According to some embodiments of the present application, the insulating portion comprises a first end and a second end opposite the first end, the first end being integrally formed with the retaining portion, and the second end being a free end.

According to some embodiments of the present application, the second end can surround and is close to a valve stem of an exhaust gas recirculation valve when cooperating with the valve stem of the exhaust gas recirculation valve.

According to some embodiments of the present application, an inner wall of the through hole of the insulating portion may be configured such that, when cooperating with the valve stem of the exhaust gas recirculation valve, an accommodating space is formed between the inner wall of the through hole of the insulating portion and the valve stem of the exhaust gas recirculation valve.

In one aspect, such an arrangement of the insulating portion may reduce contact between the integrated bushing and the valve stem, preventing the integrated bushing from interfering with the operation of the valve stem; in another aspect, arranging the second end close to the valve stem may reduce the ingress of dust, debris and contaminants, and the accommodating space may be used to accommodate ingressive dust, debris and contaminants, to prevent further ingress of dust, debris and contaminants, for example, between the valve stem and the sleeve.

According to some embodiments of the present application, the retaining portion and the insulating portion are made of stainless steel. Stainless steel has excellent corrosion resistance and meets the mechanical requirements for installing bushings.

According to a second aspect of the present application, a valve stem sealing apparatus is provided, which is used for an exhaust gas recirculation valve, characterized in that the valve stem sealing apparatus comprises:
the integrated bushing as described above;
a sealing assembly, the sealing assembly and the integrated bushing being configured to cooperate with each other to seal the valve stem of the exhaust gas recirculation valve.

According to some embodiments of the present application, the retaining portion or the insulating portion may be formed with an accommodating part, and a sealing assembly may be configured to fit in the accommodating part.

According to some embodiments of the present application, the retaining portion may be formed with a protruding part extending radially inward from an inner wall of the through hole of the retaining portion, and/or the insulating portion is formed with a protruding part extending radially inward from an inner wall of the through hole of the insulating portion, wherein the sealing assembly is configured to fit on the protruding part.

According to some embodiments of the present application, the dimensions of the through hole of the retaining portion and/or the through hole of the insulating portion are configured such that the sealing assembly is pushed toward the valve stem of the exhaust gas recirculation valve when the valve stem sealing apparatus is fitted on the valve stem of the exhaust gas recirculation valve, to enhance a sealing effect of the sealing assembly.

According to some embodiments of the present application, the sealing assembly comprises a sealing member and a retaining member, the sealing member being arranged around the retaining member on a radial outer side of the retaining member, and, when the valve stem sealing apparatus is fitted on the valve stem of the exhaust gas recirculation valve, the retaining member pressing against the valve stem of the exhaust gas recirculation valve. In one aspect, the retaining member acts to seal the valve stem, and, in another aspect, with a reciprocating movement of the valve stem, the retaining member also acts like a wiper for preventing dust, debris and contaminants from adhering to the valve stem, and preventing the ingress of dust, debris and contaminants.

According to some embodiments of the present application, the valve stem sealing apparatus further comprises at least two sealing rings that are arranged around the valve stem of the exhaust gas recirculation valve, a sleeve for the valve stem being arranged between the at least two sealing rings and the sealing assembly, and a retaining frame being provided between the at least two sealing rings. By arranging the above-mentioned sealing structures on two opposite sides of the sleeve, the sealing effect of the valve stem sealing apparatus can be significantly enhanced.

According to a third aspect of the present application, an exhaust gas recirculation valve is provided, characterized in that the exhaust gas recirculation valve comprises the valve stem sealing apparatus described above.

According to some embodiments of the present application, the exhaust gas recirculation valve comprises a valve housing, a mounting recess being formed on the valve housing, and the retaining portion being configured to be mounted in the mounting recess, such that the integrated bushing is fixed to the valve housing.

According to some embodiments of the present application, the retaining portion may be configured to be mounted in the mounting recess by an interference fit.

In one aspect, such an interference fit of the integrated bushing and the valve housing can ensure secure mounting between the two, and, in another aspect, even after the valve housing has been corroded by an exhaust gas environment, because the fitting area of the interference fit is much larger than that of other means such as riveting, the integrated bushing does not easily come off from the valve housing.

### BRIEF DESCRIPTION OF THE DRAWINGS

Multiple aspects of the present application will be better understood upon reading the following detailed description of embodiments in conjunction with the accompanying drawings, in which:

FIG. 1 is a sectional schematic drawing of an exhaust gas recirculation valve according to some embodiments of the present application;

FIG. 2 is a sectional schematic drawing of a portion of the exhaust gas recirculation valve in FIG. 1, and shows a valve stem sealing apparatus according to some embodiments of the present application;

FIG. 3 is a sectional perspective view of an integrated bushing according to some embodiments of the present application; and

FIG. 4 is a sectional perspective view of a valve stem sealing apparatus according to some embodiments of the present application.

### DETAILED DESCRIPTION

The present application will be described below with reference to the accompanying drawings, which illustrate several embodiments of the present application. It should be understood, however, that the present application may be presented in a number of different ways, and is not limited to the embodiments described below; in fact, the embodiments described below are intended to make the disclosure of the present application more complete, and fully explain to those skilled in the art the scope of protection of the present application. It should also be understood that the embodiments disclosed herein can be combined in various ways to provide further additional embodiments.

It will be understood that the same reference numerals designate the same elements throughout the accompanying drawings. In the drawings, the dimensions of certain features may be deformed for clarity.

It will be understood that the use of terms in the Description is for the purpose of describing particular embodiments only and is not intended to limit the present application. All the terms used in the Description (including technical and scientific terms) have meanings commonly understood by those skilled in the art, unless otherwise defined. Known functions or structures may not be described in detail for the sake of simplicity and/or clarity.

The singular forms “a”, “the” and “this” used in the Description all include the plural unless expressly stated. The terms “comprising”, “including” and “containing” used in the Description indicate the presence of the stated feature, but do not exclude the presence of one or more other features. The term “and/or” used in the Description comprises any and all combinations of one or more of the relevant items listed. The terms “between X and Y” and “between approximately X and Y” used in the Description shall be construed to include X and Y. The term “between approximately X and Y” used in the Description means “between approximately X and approximately Y”, and the term “from approximately X to Y” used in the Description means “from approximately X to approximately Y”.

In the Description, when one element is said to be “on” another element, “attached” to another element, “connected” to another element, “coupled” to another element, or “in contact with” another element, etc., this element may be directly on the other element, attached to the other element, connected to the other element, coupled to the other element or in contact with the other element, or an intermediate element may be present. In contrast, when one element is said to be “on” another element “directly”, “directly attached” to another element, “directly connected” to another element, “directly coupled” to another element or “directly in contact with” another element, an intermediate element may not be present. In the Description, a feature being arranged “adjacent” to another feature may refer to a feature having a portion that overlaps an adjacent feature, or a portion that is above or below the adjacent feature.

In the Description, spatial relationship terms, such as “upper”, “lower”, “left”, “right”, “front”, “rear”, “high” and “low”, can describe the relationship of one feature to another feature in the drawings. It will be understood that spatial relationship terms include different orientations of the device in use or operation, in addition to the orientations shown in the drawings. For example, when a device is inverted in the drawings, a feature originally described as “below” another feature may be described as “above” the other feature. The device can also be oriented in other ways (rotated 90 degrees or in other orientations), where the relative spatial relationship is explained accordingly.

The exhaust gas recirculation (EGR) system for internal combustion engines is a technology used to reduce harmful emissions from internal combustion engines. The exhaust gas recirculation system reduces emissions by reintroducing a portion of the exhaust gas into the engine to reduce the combustion temperature, thereby reducing the generation of nitrogen oxides (NOx).

One of the key components of the exhaust gas recirculation system is the exhaust gas recirculation valve, which controls the flow of exhaust gas and directs it into the engine. To ensure efficient operation of the exhaust gas recirculation system, the exhaust gas recirculation valve must have a good sealing performance. The design of a sealing structure not only affects the performance of the exhaust gas recirculation valve, but also directly affects the working efficiency and emission control level of the engine.

Conventional exhaust gas recirculation valve sealing structures typically comprise, from top to bottom, a sealing ring, a retaining frame, a sealing ring, a sleeve, a wiper, a heat shield and a retaining washer; this type of sealing structure has some disadvantages. For example: 1. when a valve housing is corroded by an exhaust gas environment to produce a powder, the structure cannot prevent dust from entering a gap between the sleeve and the valve stem, and, after long-term operation of the valve, the accumulation of dust causes an increase in valve stem movement resistance, with serious consequences such as causing a valve response delay and even causing the valve to jam; 2. the entry of corrosive contaminants may subsequently cause the valve stem to stick to the wiper or the sleeve, resulting in valve failure; and 3. when the valve housing is corroded by an exhaust gas environment, a rivet point of the retaining washer that is fixed on the valve housing will come off, losing a fixing effect on the retaining washer, and thus the retaining washer, the heat shield and the wiper fall off in succession.

The integrated bushing, valve stem sealing apparatus and exhaust gas recirculation valve according to the present application modify the construction of the wiper, heat shield and retaining washer, in the hope of overcoming the above-mentioned disadvantages in the prior art.

The exhaust gas recirculation valve 1 and the valve stem sealing apparatus 20 and the integrated bushing 30 thereof according to some embodiments of the present application will be described in detail below with reference to the drawings.

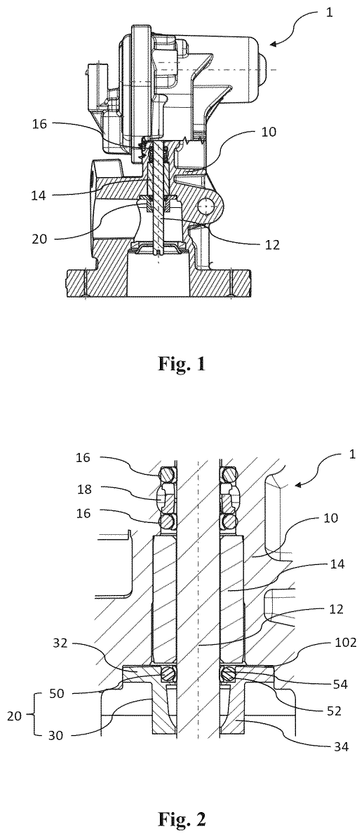

FIG. 1 shows a sectional schematic drawing of an exhaust gas recirculation valve 1 according to some embodiments of the present application. The exhaust gas recirculation valve 1 comprises a valve housing 10 and a valve stem 12, the valve stem 12 being disposed within the valve housing 10. A passage is formed in the valve housing 10 for accommodating the valve stem 12, and the valve stem 12 performs a reciprocating movement in this passage. For convenience of description, the direction of extension of the valve stem 12 (for example, the reciprocating movement direction of the valve stem 12, or the vertical direction of the page shown in FIG. 1) is defined as a longitudinal direction.

FIG. 2 shows a sectional schematic drawing of a portion of the exhaust gas recirculation valve 1 in FIG. 1. The exhaust gas recirculation valve 1 may also comprise a sealing ring 16, a sleeve 14 and a valve stem sealing apparatus 20 arranged in the passage in the longitudinal direction around the valve stem 12.

According to some embodiments, two sealing rings 16 may be provided, a retaining frame 18 is provided between the two sealing rings 16, and a sleeve 14 is below the sealing rings 16. The above structure may be any suitable structure known in the art and therefore will not be described in detail herein.

The valve stem sealing apparatus 20 according to the present application is disposed below the sleeve 14, and the valve stem sealing apparatus 20 and its related construction will be described in detail below with reference to FIGS. 2-4. According to some embodiments of the present application, the valve stem sealing apparatus 20 may comprise an integrated bushing 30 and a sealing assembly 50, the sealing assembly 50 and the integrated bushing 30 being configured to cooperate with each other to seal the valve stem 12 of the exhaust gas recirculation valve 1, protecting the valve stem 12 from the effects of dust, debris and contaminants.

According to some embodiments of the present application, the integrated bushing 30 may comprise: a retaining portion 32, the retaining portion 32 being formed with a through hole 322 and configured for mounting and fixing of the integrated bushing 30; and an insulating portion 34, the insulating portion 34 being formed with a through hole 342 and extending from the retaining portion 32, wherein the retaining portion 32 and the insulating portion 34 are integrally formed as an integral structure.

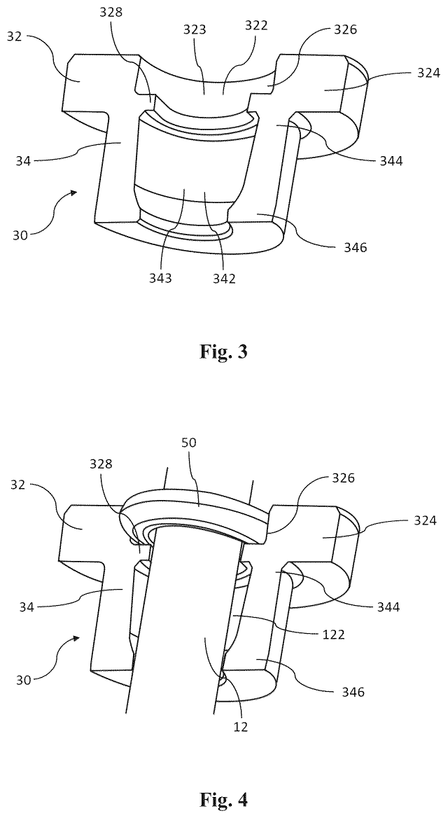

FIG. 3 shows an embodiment of an integrated bushing 30 according to the present application. The integrated bushing 30 may comprise a retaining portion 32 and an insulating portion 34 that are integrally formed. The retaining portion 32 may be formed in an annular form, and a valve stem 12 extends through the through hole 322 of the retaining portion 32. The retaining portion 32 may be used for the mounting and fixing of the integrated bushing 30, as shown in FIG. 2; by means of the retaining portion 32, the integrated bushing 30 may be mounted and fixed to the valve housing 10 of the exhaust gas recirculation valve 1. The insulating portion 34 may be formed in a cylindrical form, and the valve stem 12 extends through the through hole 342 of the insulating portion 34. The insulating portion 34 may act as a heat shield, which has an insulating effect. According to an embodiment of the present application, the retaining portion 32 and the insulating portion 34 are integrally formed as an integral structure. For example, the retaining portion 32 and insulating portion 34 may be integrally formed such that the integrated bushing 30 is formed as a single component, rather than a structure consisting of two or more components. The integrated bushing 30 is formed as a single component, which can simplify the structure of the bushing, and provides a better sealing effect, preventing dust, debris and contaminants from entering a gap between the sleeve and the valve stem which causes the valve stem to stick to relevant components, and the integrated bushing can be more securely mounted to a valve housing 10 of the exhaust gas recirculation valve 1 (as described below).

According to some embodiments of the present application, a retaining portion 32 may comprise a flange 324, the flange 324 being arranged around a through hole 322 of the retaining portion 32. As shown in FIG. 3, the flange 324 is located on a radial outer side of the through hole 322, the flange 324 being mainly used for mounting and fixing, and the integrated bushing 30 can be mounted and fixed to the valve housing 10 of the exhaust gas recirculation valve 1 by means of the flange 324.

According to some embodiments of the present application, the insulating portion 34 may comprise a first end 344 and a second end 346 opposite the first end 344, the first end 344 being integrally formed with the retaining portion 32, and the second end 346 being a free end. As shown in FIG. 3, the insulating portion 34 extends in a longitudinal direction from the first end 344 to the second end 346, so that the insulating portion 34 as a whole extends in the longitudinal direction from the retaining portion 32. An outer diameter of the first end 344 may be equal to an outer diameter of the second end 346, or may be greater than the outer diameter of the second end 346. According to some embodiments, the outer diameter of the retaining portion 32 may be larger than or equal to the outer diameter of the insulating portion 34. In the embodiments shown, the outer diameter of the retaining portion 32 is larger than the outer diameter of the insulating portion 34, i.e., the retaining portion 32 projects radially outward relative to the insulating portion 34. In some embodiments, it is conceivable that the outer diameter of the retaining portion 32 is equal to the outer diameter of the insulating portion 34, such that the integrated bushing 30 is formed as a whole in a generally cylindrical form. Even in some other embodiments, the outer diameter of the retaining portion 32 may be smaller than the outer diameter of the insulating portion 34.

According to some embodiments of the present application, the second end 346 can surround and is close to a valve stem 12 of an exhaust gas recirculation valve 1 when cooperating with the valve stem 12 of the exhaust gas recirculation valve 1. As shown in FIG. 4, the valve stem 12 extends through the retaining portion 32 and the insulating portion 34 of the integrated bushing 30, i.e. through the through hole 322 of the retaining portion 32 and the through hole 342 of the insulating portion 34, so that both the retaining portion 32 and the insulating portion 34 are arranged around the valve stem 12. The second end 346 of the insulating portion 34 may be as close as possible to the valve stem 12 so as to form a slight gap between the second end 346 and the valve stem 12. The second end 346 is arranged close to the valve stem 12 to reduce the ingress of dust, debris and contaminants.

According to some embodiments of the present application, an inner wall 343 of the through hole 342 of the insulating portion 34 may be configured such that, when cooperating with the valve stem 12 of the exhaust gas recirculation valve 1, an accommodating space 122 is formed between the inner wall 343 of the through hole 342 of the insulating portion 34 and the valve stem 12 of the exhaust gas recirculation valve 1. As shown in FIG. 4, the inner wall 343 of the through hole 342 of the insulating portion 34 may be formed to have a non-linear shape, such as an arcuate shape or a curved shape, such that when the second end 346 is close to the valve stem 12, a portion between the first end 344 and the second end 346, and the first end 344 move radially away from the valve stem 12 relative to the second end 346, to form an accommodating space 122. In one aspect, such an arrangement of the insulating portion 34 may reduce contact between the integrated bushing 30 and the valve stem 12, preventing the integrated bushing 30 from interfering with the operation of the valve stem 12; in another aspect, arranging the second end 346 close to the valve stem 12 may reduce the ingress of dust, debris and contaminants, and the accommodating space 122 may be used to accommodate ingressive dust, debris and contaminants, to prevent further ingress of dust, debris and contaminants, for example, between the valve stem and the sleeve.

According to some embodiments of the present application, the retaining portion 32 and the insulating portion 34 may be made of stainless steel. Stainless steel has excellent corrosion resistance and meets the mechanical requirements for installing bushings. It will be understood by those skilled in the art that that retaining portion 32 and insulating portion 34 may also be made of any other suitable material.

According to some embodiments of the present application, the retaining portion 32 or the insulating portion 34 may be formed with an accommodating part 326, and a sealing assembly 50 may be configured to fit in the accommodating part 326. As shown in FIGS. 2 and 4, the accommodating part 326 is formed on the retaining portion 32 to accommodate the sealing assembly 50, and, by means of the accommodating part 326, the sealing assembly 50 can be fitted on the integrated bushing 30 and supported and retained by the integrated bushing 30; thus, the sealing assembly 50 and the integrated bushing 30 can cooperate with each other to seal the valve stem 12 of the exhaust gas recirculation valve 1, protecting the valve stem 12 from the effects of dust, debris and contaminants. It is conceivable that the accommodating part 326 may also be formed on another portion of the integrated bushing 30; for example, in an embodiment not shown, the accommodating part 326 may be formed on the insulating portion 34.

According to some embodiments of the present application, the retaining portion 32 may be formed with a protruding part 328 extending radially inward from an inner wall 323 of the through hole 322 of the retaining portion 32, and/or the insulating portion 34 is formed with a protruding part extending radially inward from an inner wall 343 of the through hole 342 of the insulating portion 34, wherein the sealing assembly 50 may be configured to fit on the protruding part 328.

As shown in FIGS. 2 to 4, the retaining portion 32 is formed with a protruding part 328, the protruding part 328 extending radially inward from an inner wall 323 of the through hole 322 of the retaining portion 32, i.e. toward the valve stem 12; the inner wall 323 of the through hole 322 of the retaining portion 32 and the protruding part 328 may thereby form an accommodating part 326 to accommodate the sealing assembly 50. The protruding part 328 may extend radially inward toward the valve stem 12 to be close to the valve stem 12; a slight gap may be formed between the protruding part 328 and the valve stem 12 to reduce the ingress of dust, debris and contaminants. It will be understood by those skilled in the art that the above-mentioned protruding part may also be formed on another portion of the integrated bushing 30; for example, in an embodiment not shown, the protruding part 328 may extend radially inward from the inner wall 343 of the through hole 342 of the insulating portion 34, and the inner wall 343 of the through hole 342 of the insulating portion 34 forms an accommodating part 326 to accommodate the sealing assembly 50.

In some other embodiments, an annular recess may be formed on an inner wall 323 of a through hole 322 of a retaining portion 32 and/or an inner wall 343 of a through hole 342 of an insulating portion 34, and a sealing assembly 50 may fit directly in this annular recess to be supported and retained by an integrated bushing 30.

According to some embodiments of the present application, the dimensions of the through hole 322 of the retaining portion 32 and/or the through hole 342 of the insulating portion 34 may be configured such that the sealing assembly 50 is pushed toward the valve stem 12 of the exhaust gas recirculation valve 1 when the valve stem sealing apparatus 20 is fitted on the valve stem 12 of the exhaust gas recirculation valve 1.

As shown in FIGS. 2 and 4, an inner diameter of a through hole 322 of a retaining portion 32 may be set to be slightly smaller than an outer diameter of a sealing assembly 50, such that the sealing assembly 50 may be mounted in an interference fit or a pressure fit, for example, in the accommodating part 326 of the integrated bushing 30, so that an inner wall 323 of the through hole 322 of the retaining portion 32 exerts a radially inward pressure on the sealing assembly 50, pushing the sealing assembly 50 toward the valve stem 12 of the exhaust gas recirculation valve 1 to enhance the sealing effect of the sealing assembly 50.

According to some embodiments of the present application, the sealing assembly 50 may comprise a sealing member 52 and a retaining member 54, the sealing member 52 being arranged around the retaining member 54 on a radial outer side of the retaining member 54, and, when the valve stem sealing apparatus 20 is fitted on the valve stem 12 of the exhaust gas recirculation valve 1, the retaining member 54 pressing against the valve stem 12 of the exhaust gas recirculation valve 1.

As shown in FIG. 2, the sealing member 52 may be formed as an outer ring of sealing assembly 50, the retaining member 54 may be formed as an inner ring of sealing assembly 50, and sealing member 52 and retaining member 54 may be assembled together by a pressure fit, for example. The inner diameter of the retaining member 54 may be slightly smaller than the outer diameter of the valve stem 12, such that the retaining member 54 is fitted to the valve stem 12 in an interference fit for a good sealing effect. In one aspect, the retaining member 54 acts to seal the valve stem 12, and, in another aspect, with a reciprocating movement of the valve stem 12, the retaining member 54 also acts like a wiper for preventing dust, debris and contaminants from adhering to the valve stem 12, and preventing the ingress of dust, debris and contaminants.

According to some embodiments of the present application, the valve stem sealing apparatus 20 further comprises at least two sealing rings 16 that are arranged around the valve stem 12 of the exhaust gas recirculation valve 1, a sleeve 14 for the valve stem 12 being arranged between the at least two sealing rings 16 and the sealing assembly 50, and a retaining frame 18 being provided between the at least two sealing rings 16.

As shown in FIG. 2, the sealing ring 16, the retaining frame 18, the sealing ring 16, the sleeve 14 and the sealing assembly 50 are arranged sequentially around the valve stem 12 in a longitudinal direction from top to bottom, and two or more sealing rings 16 and the sealing assembly 50 are arranged on two opposite sides of the sleeve 14, forming a multi-sealing structure, for example, in the illustrated embodiment, forming a triple sealing structure; in other embodiments, a sealing structure of a higher multiple may be formed. In some embodiments, the construction of the sealing ring 16 may be similar to the sealing assembly 50, such that, in one aspect, the sealing ring 16 acts to seal the valve stem 12, and, in another aspect, with a reciprocating movement of the valve stem 12, the sealing ring 16 also acts like a wiper for preventing dust, debris and contaminants from adhering to the valve stem 12, and preventing the ingress of dust, debris and contaminants. By arranging the above-mentioned sealing structures on two opposite sides of the sleeve 14, the sealing effect of the valve stem sealing apparatus 20 can be significantly enhanced.

According to some embodiments of the present application, a mounting recess 102 is formed on the valve housing 10, and the retaining portion 32 is configured to be mounted in the mounting recess 102, such that the integrated bushing 30 is fixed to the valve housing 10.

As shown in FIG. 2, below the sleeve 14, the valve housing 10 is formed with a mounting recess 102, and a flange 324 of the retaining portion 32 is mounted in this mounting recess 102; thus, the integrally formed integrated bushing 30 can be fixed to the valve housing 10.

According to some embodiments of the present application, a retaining portion 32 may be configured to be mounted in the mounting recess 102 by an interference fit. In particular, an outer diameter of the flange 324 of the retaining portion 32 may be formed to be slightly larger than an inner diameter of the mounting recess 102, such that the flange 324 of the retaining portion 32 forms an interference fit with the mounting recess 102, thereby securely fixing the integrated bushing 30 to the valve housing 10. In one aspect, such an interference fit of the integrated bushing 30 and the valve housing 10 can ensure secure mounting between the two, and, in another aspect, even after the valve housing has been corroded by an exhaust gas environment, because the fitting area of the interference fit is much larger than that of other means such as riveting, the integrated bushing 30 does not easily come off from the valve housing 10.

While exemplary embodiments of the present application have been described, it will be understood by those skilled in the art that various changes and modifications can be made to the exemplary embodiments of the present application without essentially departing from the spirit and scope of the present application. Accordingly, all changes and modifications are included within the scope of protection of the present application as defined in the claims. The present application is defined by the appended claims, and equivalents of these claims are included therein.

### LIST OF REFERENCE SIGNS

Exhaust gas recirculation valve 1;
Valve housing 10; valve stem 12; sleeve 14; sealing ring 16; retaining frame 18; mounting recess 102; accommodating space 122;
Valve stem sealing apparatus 20;
Integrated bushing 30; retaining portion 32; insulating portion 34; through hole 322; inner wall 323; flange 324; accommodating part 326; protruding part 328; through hole 342; inner wall 343; first end 344; second end 346;
Sealing assembly 50; sealing member 52; retaining member 54.

1. An integrated bushing, which is used for an exhaust gas recirculation valve, the integrated bushing comprising:
a retaining portion, the retaining portion being formed with a through hole and being configured for mounting and fixing of the integrated bushing; and
an insulating portion, the insulating portion being formed with a through hole and extending from the retaining portion,
wherein the retaining portion and the insulating portion are integrally formed as an integral structure.

2. An integrated bushing according to claim 1, wherein the retaining portion comprises a flange, and the flange is arranged around a through hole of the retaining portion.

3. An integrated bushing according to claim 1, wherein the insulating portion comprises a first end and a second end opposite the first end, the first end being formed integrally with the retaining portion, and the second end being a free end.

4. An integrated bushing according to claim 3, wherein the second end is configured to surround and be close to a valve stem of the exhaust gas recirculation valve when cooperating with the valve stem.

5. An integrated bushing according to claim 1, wherein an inner wall of the through hole of the insulating portion is configured such that, when cooperating with a valve stem of the exhaust gas recirculation valve, an accommodating space is formed between the inner wall of the through hole of the insulating portion and the valve stem.

6. An integrated bushing according to claim 1, wherein the retaining portion and the insulating portion are made of stainless steel.

7. A valve stem sealing apparatus, which is used for an exhaust gas recirculation valve, the valve stem sealing apparatus comprising:
the integrated bushing according to claim 1; and
a sealing assembly, the sealing assembly and the integrated bushing being configured to cooperate with each other to seal a valve stem of the exhaust gas recirculation valve.

8. A valve stem sealing apparatus according to claim 7, wherein the retaining portion or the insulating portion is formed with an accommodating part, and the sealing assembly is configured to fit in the accommodating part.

9. A valve stem sealing apparatus according to claim 7, wherein the retaining portion is formed with a protruding part extending radially inward from an inner wall of the through hole of the retaining portion, and/or the insulating portion is formed with a protruding part extending radially inward from an inner wall of the through hole of the insulating portion, and wherein the sealing assembly is configured to fit on the protruding part.

10. A valve stem sealing apparatus according to claim 7, wherein the dimensions of the through hole of the retaining portion and/or the through hole of the insulating portion are configured such that the sealing assembly is pushed toward the valve stem of the exhaust gas recirculation valve when the valve stem sealing apparatus is fitted on the valve stem.

11. A valve stem sealing apparatus according to claim 7, wherein the sealing assembly comprises a sealing member and a retaining member, the sealing member being arranged around the retaining member on a radial outer side of the retaining member, and, when the valve stem sealing apparatus is fitted on the valve stem of the exhaust gas recirculation valve, the retaining member pressing against the valve stem.

12. A valve stem sealing apparatus according to claim 7, further comprising at least two sealing rings that are arranged around the valve stem of the exhaust gas recirculation valve, a sleeve for the valve stem arranged between the at least two sealing rings and the sealing assembly, and a retaining frame provided between the at least two sealing rings.

13. An exhaust gas recirculation valve comprising the valve stem sealing apparatus according to claim 7.

14. An exhaust gas recirculation valve according to claim 13, further comprising a valve housing, a mounting recess formed on the valve housing wherein the retaining portion is configured to be mounted in the mounting recess, such that the integrated bushing is fixed to the valve housing.

15. An exhaust gas recirculation valve according to claim 14, characterized in that the retaining portion is configured to be mounted in the mounting recess by an interference fit.
